(19) United States
(12) Patent Application Publication
(10) Pub. No.: US 2026/0064054 A1
(43) Pub. Date: Mar. 5, 2026

(54) FIXING DEVICE AND IMAGE FORMING APPARATUS

(71) Applicant: KYOCERA Document Solutions Inc., Osaka (JP)

(72) Inventor: Hiroki KAWASAKI, Osaka (JP)

(73) Assignee: KYOCERA Document Solutions Inc., Osaka (JP)

(21) Appl. No.: 19/298,131

(22) Filed: Aug. 12, 2025

(30) Foreign Application Priority Data
Aug. 28, 2024 (JP) 2024-146629

(51) Int. Cl. G03G 15/20; G03G 15/00

(52) U.S. Cl. CPC G03G 15/2053; G03G 15/2039; G03G 15/2064; G03G 15/657; G03G 2215/00721; G03G 2215/2035

(57) ABSTRACT

A fixing device includes a fixing belt, a pressure member, a heater, and a heat source temperature detection device. The heat source temperature detection member detects a temperature of the heater. The heater includes a substrate and a heat generating part. The substrate extends in an axial direction of the fixing belt. The heat generating part is formed at a position shifted in one direction from a center in the axial direction on one surface of the substrate facing the pressure region, and generates heat when being powered. The heater is divided into a short region having a shorter length in the axial direction and a long region having a longer length in the axial direction by the center of the heat generating part in the axial direction as a boundary. The heat source temperature detection member is disposed in the short region of the heater.

### INCORPORATION BY REFERENCE

This application is based on and claims the benefit of priority from Japanese patent application No.2024-146629 Aug. 28, 2024, which is incorporated by reference in its entirety.

### TECHNICAL FIELD

The present disclosure relates to a fixing device which fixes a toner image on a medium and an image forming apparatus.

### BACKGROUND

A fixing device including a heater for heating a paper and end-side and center-side thermistors for detecting the temperature of the heater is known. The heater has a substrate and a resistance heating element, and has a large heat distributed area on one side and a small heat distributed area on the other side in a conveyance orthogonal direction with respect to the center position (reference position) of the resistance heating element in the conveyance orthogonal direction. The end-side thermistor is provided in the small heat distributed area to detect the temperature inside the fixing device and to prevent fixing failure.

However, in the above-mentioned fixing device, since the temperature in the small heat distributed area rises later than in the large heat distributed area, the end-side thermistor provided in the small heat distributed area may not be able to detect an abnormal temperature rise of the heater in a timely manner. Therefore, it may not be possible to suppress the breakdown of the fixing device due to excessive heating.

### SUMMARY

A fixing device according to the present disclosure includes a fixing belt, a pressure member, a heater, a heat source temperature detection device. The fixing belt is formed in a cylindrical shape and heats toner on a medium while rotating around an axis. The pressure member forms a pressure region between the fixing belt and the pressure member, and pressurizes the toner on the medium passing through the pressure region while rotating around an axis. The heater is in contact with an inner surface of the fixing belt in the pressure region and heats the fixing belt. The heat source temperature detection member detects a temperature of the heater. The heater includes a substrate and a heat generating part. The substrate extends in an axial direction of the axis of the fixing belt. The heat generating part is formed at a position shifted in one direction from a center in the axial direction on one surface of the substrate facing the pressure region, and generates heat when being powered. The heater is divided into a short region having a shorter length in the axial direction and a long region having a longer length in the axial direction by the center of the heat generating part in the axial direction as a boundary. The heat source temperature detection member is disposed in the short region of the heater.

An image forming apparatus according to the present disclosure includes the fixing device.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a schematic view (side view) showing an internal structure of an image forming apparatus according to one embodiment of the present disclosure.

FIG. 2 is a perspective view showing a fixing device according to the embodiment of the present disclosure.

FIG. 3 is a cross-sectional view taken along the line III-III of FIG. 2.

FIG. 4 is a bottom view showing a heater of the fixing device according to the embodiment of the present disclosure.

FIG. 5 is a block diagram showing a detection structure of the fixing device according to the embodiment of the present disclosure.

FIG. 6 is a view explaining the heater and the detection structure of the heater and a temperature distribution of the heater and the detection structure of the fixing device according to the embodiment of the present disclosure.

### DETAILED DESCRIPTION

Hereinafter, with reference to the attached drawings, an embodiment of the present disclosure will be described. Fr, Rr, L, R, U and D shown in the drawings indicate front, rear, left, right, upper and lower. The front-and-rear direction, the left-and-right direction (axial direction), and the upper-and-lower direction are orthogonal to each other. Although terms indicating direction and position are used herein, these terms are used for convenience of explanation and are not intended to limit the scope of the disclosure. The terms “upstream”, “downstream”, and the related terms refer to “upstream”, “downstream” in the conveyance direction of the paper P (medium), and the related concepts. In each of the figures, the dimensions and angles of the members are not accurate and are schematized for the sake of illustration.

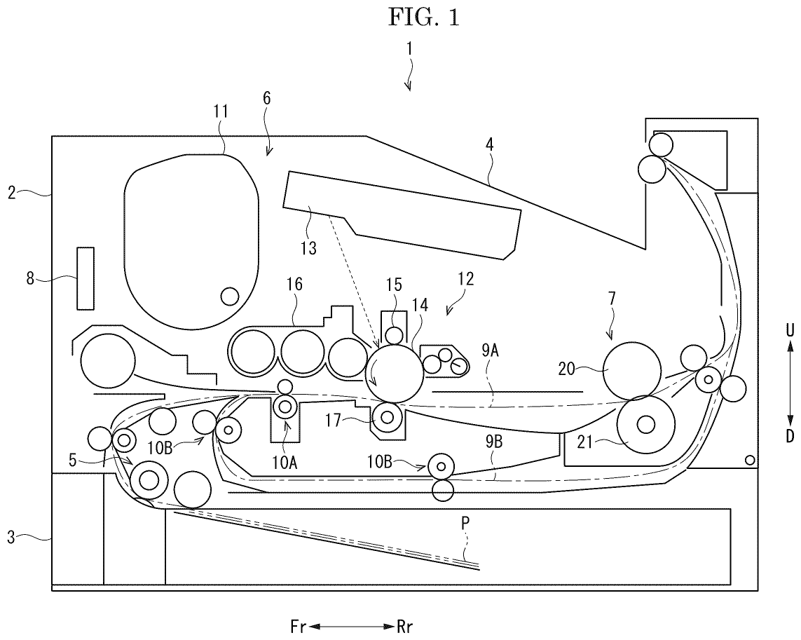

With reference to FIG. 1, an image forming apparatus 1 according to the present embodiment will be described. FIG. 1 is a schematic view (side view) showing the image forming apparatus 1.

The image forming apparatus 1 is an electrophotographic printer. The image forming apparatus 1 includes an apparatus main body 2 constituting a substantially rectangular parallelepiped appearance. A paper feeding cassette 3 which stores a paper P (medium), for example, is detachably provided at the lower portion of the apparatus main body 2. A paper discharge tray 4 is provided on the upper surface of the apparatus main body 2. The paper P as an example of the medium is not limited to a paper but may be a resin sheet or the like.

The image forming apparatus 1 includes a paper feeding device 5, an image forming device 6, and a fixing device 7. The paper feeding device 5 is provided at the upstream end of a conveyance path 9A extending from the paper feeding cassette 3 to the paper discharge tray 4, and feeds the papers P stored in the paper feeding cassette 3 to the conveyance path 9A one by one. The image forming device 6 is provided in the intermediate portion of the conveyance path 9A and forms a toner image on the conveyed paper P. The fixing device 7 is provided on the downstream portion of the conveyance path 9A and thermally fixes the toner image to the paper P.

On the conveyance path 9A, a pair of registration rollers 10 which temporarily blocks the conveyed paper P and corrects the skew of the paper P (skew correction) is provided. An inversion conveyance path 9B is provided below the conveyance path 9A, which branches at the downstream portion of the conveyance path 9A and merges with the upstream portion of the conveyance path 9A. On the inversion conveyance path 9B, a plurality of pairs of conveying rollers 10B for conveying the paper P are provided.

The image forming device 6 includes a toner container 11, a drum unit 12, and an optical scanner 13. The toner container 11 is disposed in the front upper portion of the apparatus main body 2, and contains, for example, black toner (developer). The drum unit 12 includes a photosensitive drum 14, a charging device 15, a developing device 16, and a transfer roller 17. The photosensitive drum 14 is formed in a substantially cylindrical shape, and is driven to be rotated around an axis by a motor (not shown). The charging device 15, the developing device 16 and the transfer roller 17 are arranged around the photosensitive drum 14 in the order of the image forming process. The transfer roller 17 is in contact with the photosensitive drum 14 from the lower side to form a transfer nip. The optical scanner 13 is provided above the photosensitive drum 14, and emits scanning light toward the surface of the photosensitive drum 14.

The image forming apparatus 1 is provided with a control device 8 for controlling the entire apparatus. The control device 8 may be configured by a processor or a logic circuit (hardware) formed in an integrated circuit or the like. In the case of the processor, the processor reads and executes programs stored in a memory to performs various processes.

[Image Forming Process] The control device 8 for controlling the image forming apparatus 1 performs an image forming process based on image data input from an external terminal as follows.

The charging device 15 charges the surface of the photosensitive drum 14, and the optical scanner 13 emits scanning light based on the image data to form an electrostatic latent image on the photosensitive drum 14. The developing device 16 develops the electrostatic latent image on the photosensitive drum 14 into a toner image using the toner replenished from the toner container 11. The paper feeding device 5 feeds the paper P one by one from the paper feeding cassette 3 to the conveyance path 9A. The paper P is conveyed along the conveyance path 9A, after the skew is corrected by the pair of registration rollers 10A, the paper P enters the transfer nip. The transfer roller 17 transfers the toner image on the photosensitive drum 14 to the surface of the paper P passing through the transfer nip. The fixing device 7 thermally fixes the toner image to the paper P. In the case of single-sided printing, the paper P which has passed through the fixing device 7 is discharged to the paper discharge tray 4.

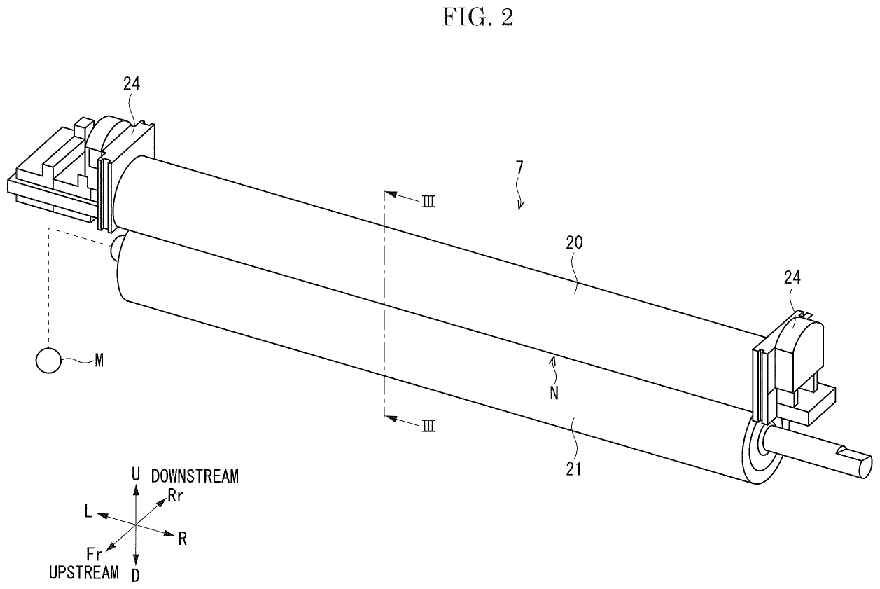

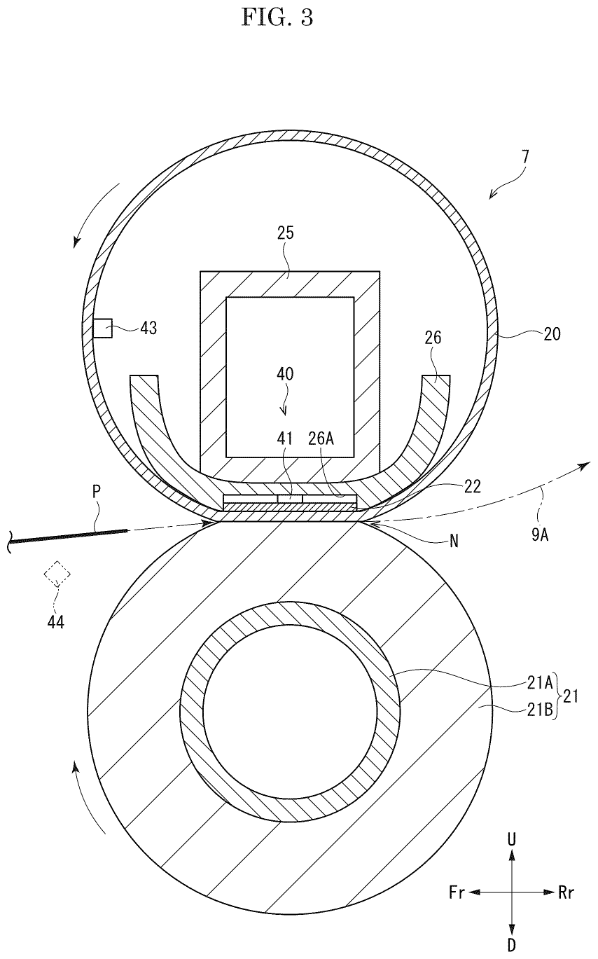

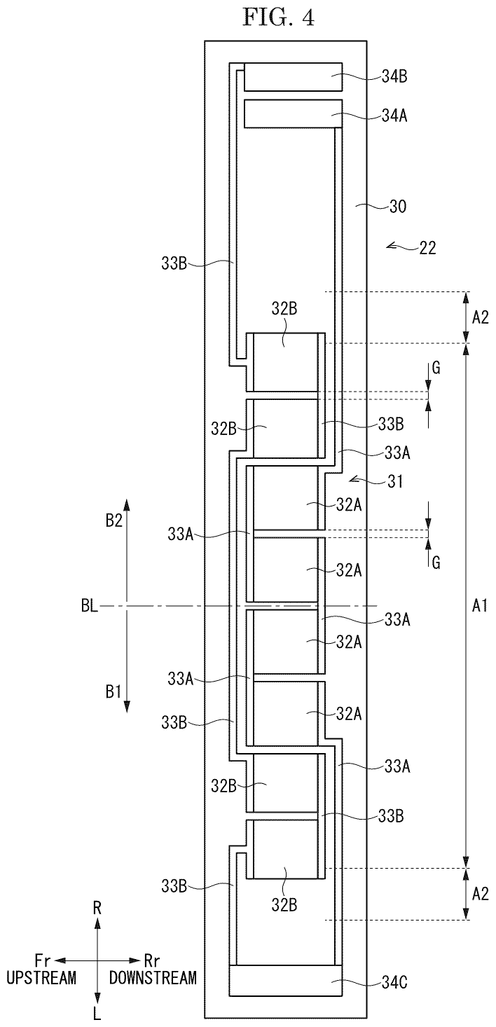

In the case of double-sided printing, the paper P which has passed through the fixing device 7 is switched back at the downstream end of the conveyance path 9A, and sent to the inversion conveyance path 9B. The paper P is conveyed by the pair of conveying rollers 10B, returned from the inversion conveyance path 9B to the conveyance path 9A again, and sent to the transfer nip after the skew correction by the pair of registration rollers 10A. Thereafter, the toner image is transferred to the paper P, and thermally fixed, and the double-sided printed paper P is discharged to the paper discharge tray 4.

[Fixing Device] Next, the fixing device 7 will be described with reference to FIG. 2 to FIG. 4. FIG. 2 is a perspective view showing the fixing device 7. FIG. 3 is a cross-sectional view taken along the line III-III of FIG. 2. FIG. 4 is a bottom view showing a heater 22.

As shown in FIG. 2 and FIG. 3, the fixing device 7 includes a fixing belt 20, a pressure roller 21, and a heater 22. The fixing belt 20 and the pressure roller 21 are supported by a frame (not shown), and the frame is fixed to the apparatus main body 2.

<Fixing Belt> The fixing belt 20 is an endless belt formed in a substantially cylindrical shape elongated in the left-and-right direction (axial direction). The fixing belt 20 is made of material having heat resistance and flexibility (polymer resin or metal, or combination of polymer resin and metal). A pair of holding members 24 (see FIG. 2) are inserted into both right and left ends of the fixing belt 20. The pair of holding members 24 guide the fixing belt 20 rotatably around an axis while holding the fixing belt in a substantially cylindrical shape. The fixing belt 20 is supported by the frame via the pair of holding members 24 (not shown).

As shown in FIG. 3, an erection member 25 and a support member 26 are provided in a space surrounded by the fixing belt 20. The erection member 25 is made of, for example, metallic material such as stainless steel, and formed in a substantially rectangular cylindrical shape elongated in the left-and-right direction (axial direction), and is erected between the pair of holding members 24. The support member 26 is fixed to the lower portion of the erection member 25. The support member 26 is made, for example, of synthetic resin having heat resistance and wear resistance, and formed in a substantially semi-cylindrical shape elongated in the left-and-right direction. The support member 26 is curved along the inner surface of the fixing belt 20 and is in contact with the lower portion (the portion on the side of a pressure region N) of the inner surface of the fixing belt 20. A fitting portion 26A into which the heater 22 is fitted is recessed in the lower portion of the support member 26.

<Pressure Roller> As shown in FIG. 2 and FIG. 3, the pressure roller 21 as an example of the pressure member is formed in a substantially cylindrical shape elongated in the left-and-right direction. The pressure roller 21 has a metal core 21A and an elastic layer 21B such as a silicon sponge laminated on the outer peripheral surface of the metal core 21A (see FIG. 3). A drive motor M is connected to the left end of the metal core 21A via a gear train (not shown) (see FIG. 2). The pressure roller 21 comes into contact with the fixing belt 20 from the lower side and forms a pressure region N between the fixing belt 20 and the pressure roller 21. When the paper P passes through the pressure region N, the toner image is fixed on the paper P. The pressure region N refers to from an upstream position where the pressure is 0 Pa to a downstream position where the pressure is 0 Pa again via a position where the pressure acts.

<Heater> As shown in FIG. 3, the heater 22 is fitted into the fitting portion 26A of the support member 26. The heater 22 comes into contact with the inner surface of the fixing belt 20 facing the pressure region N, and heats the fixing belt 20. As shown in FIG. 4, the heater 22 includes a substrate 30 extending in the left-and-right direction (axial direction) and a heat generating part 31 which generate heat by being powered.

(Substrate) The substrate 30 is made of, for example, insulator (electrical insulating material) such as ceramic, and is formed in a substantially rectangular plate shape elongated in the left-and-right direction (axial direction). The size of the substrate 30 (the heater 22) in the axial direction longer than the size of the fixing belt 20 in the axial direction.

(Heating Part) the Heat Generating Part 31 is provided on the lower surface (one surface) of the substrate 30 facing the pressure region N across the fixing belt 20. The heat generating part 31 is formed at a position shifted in one direction (left direction in FIG. 4) from the center in the left-and-right direction (axial direction) on the lower surface of the substrate 30. The heater 22 is divided into a short region B1 on one side (left side) in the axial direction and a long region B2 on the other side (right side) in the axial direction by the center of the heat generating part 31 in the axial direction as a boundary BL.

The heat generating part 31 has four first resistance heating elements 32A and four second resistance heating elements 32B. Each of the first resistance heating element 32A and the second resistance heating element 32B is made of metal material having a high electrical resistance, and formed in a substantially rectangular shape. The four first resistance heating elements 32A and the four second resistance heating elements 32B are arranged in a line in the axial direction across a gap G. The four first resistance heating elements 32A are arranged in the central region of the heat generating part 31 in the axial direction, and the four second resistance heating elements 32B are arranged two by two on both sides of the four first resistance heating elements 32A in the axial direction. The four first resistance heating elements 32A and the four second resistance heating elements 32B are arranged so as to be linearly symmetric in the axial direction (left-and-right direction) with the boundary BL as the axis of symmetry. In this specification, when the four first resistance heating elements 32A and the four second resistance heating elements 32B are collectively described, they are simply referred to as “resistance heating elements 32”, and only arithmetic numerals are attached to the reference numerals. The gap G is set to an insulation distance (creepage distance) capable of preventing creeping discharge between the adjacent resistance heating elements 32.

The paper P is generally conveyed so that the center of the width in the left-and-right direction substantially coincides with the center of the pressure region N in the left-and-right direction (axial direction). For this reason, the fixing belt 20 (or the pressure region N) is provided with a passing region A1 which is the center region in the axial direction and is in contact with the paper P, and non-passing regions A2 which are the side end regions in the axial direction and are not in contact with the paper P (see FIG. 4). An axial dimension of the entire heat generating part 31 is shorter than the total length of the fixing belt 20 in the left-and-right direction (axial direction) and is longer than the passing region A1 of the fixing belt 20 in the axial direction.

The paper P to be conveyed always comes into contact with the vicinity of the center of the passing region A1 in the axial direction, regardless of the size (dimension in the left-and-right direction) of the paper P. The four first resistance heating elements 32A correspond to the vicinity of the center of the passing region A1 in the axial direction. More specifically, the four first resistance heating elements 32A correspond to the widths of the paper P of small sizes (for example, A5 and B5 sizes) in the left-and-right direction. On the other hand, the paper P of a normal size (for example, A4 size) is brought into contact with both side portions of the passing region A1 in the axial direction, but the paper P of a small size is not brought into contact. The four second resistance heating elements 32B correspond to both sides of the passing region A1 in the axial direction. All the resistance heating elements 32 (the heat generating part 31) correspond to the entire passing region A1, and correspond to the width of the paper of a normal size in the left-and-right direction.

On the lower surface of the substrate 30, a plurality of first wirings 33A, a plurality of second wirings 33B, a first terminal 34A, a second terminal 34B, and a common terminal 34C are formed. In this specification, when the plurality of first wirings 33A and the plurality of second wirings 33B are collectively described, they are simply referred to as “wirings 33”, and only arithmetic numerals are attached to the reference numerals. When the first terminal 34A, the second terminal 34B, and the common terminal 34C are collectively described, they are simply referred to as “terminal 34”, and only arithmetic numerals are attached to the reference numerals.

The wiring 33 and the terminal 34 are made of, for example, metal material having an electrical resistance lower than that of the resistance heating element 32. The plurality of first wirings 33A are connected to the upstream end or the downstream end of the axially adjacent first resistance heating element 32A. The four first resistance heating elements 32A are connected in series by the plurality of first wiring 33A. The plurality of second wirings 33B are connected to the downstream ends of the axially adjacent second resistance heating elements 32B, and are connected to the upstream ends of the two second resistance heating elements 32B which are axially spaced apart across the four first resistance heating elements 32A. The four second resistance heating elements 32B are connected in series by the plurality of second wirings 33B.

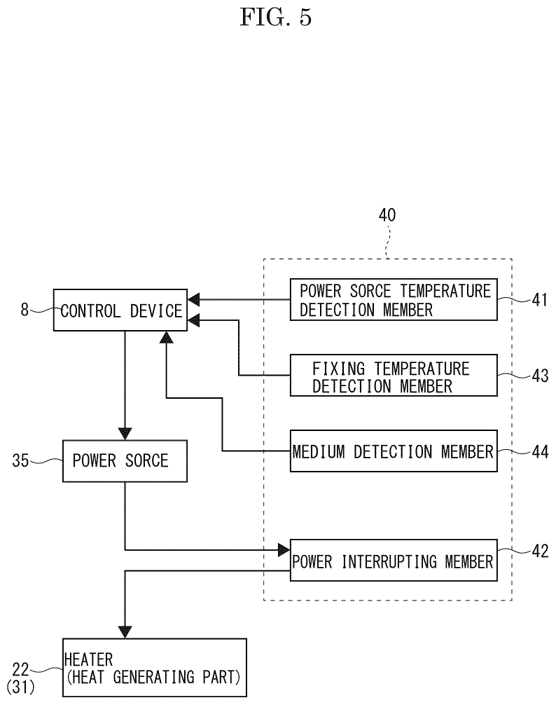

The first terminal 34A and the second terminal 34B are disposed at the right end portion of the substrate 30 (the long region B2), and the common terminal 34C is disposed at the left end portion of the substrate 30 (the short region B1). The downstream end of the first resistance heating element 32A located at the right end is connected to the downstream end of the first terminal 34A via the first wiring 33A. The downstream end of the first resistance heating element 32A located at the left end is connected to the downstream end of the common terminal 34C via the first wiring 33A. The upstream end of the second resistance heating element 32B located at the right end is connected to the upstream end of the second terminal 34B via the second wiring 33B. The upstream end of the second resistance heating element 32B located at the left end is connected to the upstream end of the common terminal 34C via the second wiring 33B. The terminal 34 is electrically connected to a device such as a power source 35 (see FIG. 5, which will be described later).

The heat generating part 31, the wirings 33, and the terminals 34 are covered with a coating layer (not shown). The heater 22 is fitted into the fitting portion 26A of the support member 26, and brings the coat layer into contact with the inner surface of the fixing belt 20. When the heater 22 receives the fixing belt 20 pressed against the pressure roller 21, the pressure region N is formed in the contact portion between the fixing belt 20 and the pressure roller 21 (see FIG. 3). The heater 22, the drive motor M, and the others are electrically connected to the control device 8, the power source 35, and the others, and are appropriately controlled by the control device 8.

[Fixing Process] Here, the operation (fixing process) of the fixing device 7 will be described. The control device 8 controls the drive motor M to rotate the pressure roller 21 around the axis. The fixing belt 20 rotates in accordance with the pressure roller 21 (see the arrow in FIG. 3). The control device 8 receives a detection signal from a heat source temperature detection member 41 or the others and controls the heater 22 (or the power source) so as to maintain a preset target temperature. The heater 22 generate heat by being powered, and heat the fixing belt 20 (pressure region N).

At this time, the control device 8 changes the resistance heating elements 32 for heating (being powered) according to a size of the paper P. For example, when the paper P of a normal size passes through the pressure region N, the control device 8 executes control for heating all the resistance heating elements 32. When the paper P of a small size passes through the pressure region N, the control device 8 executes control for heating only the four first resistance heating elements 32A. Thus, only a necessary area of the fixing belt 20 (pressure region N) can be heated in accordance with the size of the paper P. As a result, the power used can be kept to a minimum. It is also possible to suppress excessive temperature rise at both the axial end portions of the fixing belt 20.

When the temperature of the fixing belt 20 (heater 22) reaches the target temperature, the control device 8 starts the image forming process already described. The paper P on which the toner image is transferred enters the pressure region N. The fixing belt 20 heats the toner (toner image) on the paper P passing through the pressure region N while rotating around the axis. The pressure roller 21 pressurizes the toner on the paper P passing through the pressure region N while rotating around the axis. Then, the toner image is fixed to the paper P, and a fixed image is formed on the paper P. The paper P on which the image is fixed is discharged to the paper discharge tray 4.

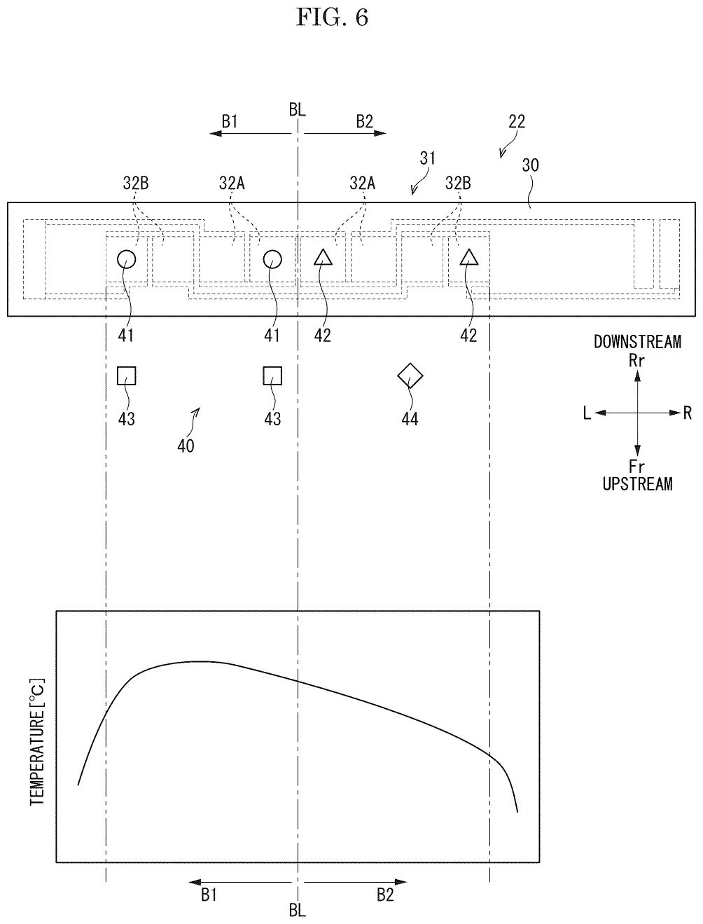

In the fixing device 7, the fixing belt 20 is required to be maintained at a target temperature in order to perform proper fixing process. The fixing device 7 is also required to prevent excessive temperature rise of the fixing belt 20, the heater 22 and the others when the heater 22, the control device 8 and the others do not operate normally due to failure or the like. Therefore, the fixing device 7 according to the present embodiment includes a detection structure 40 for preventing excessive temperature rise while ensuring proper fixing process.

[Detection Structure] The detection structure 40 will be described with reference to FIG. 3, FIG. 5 and FIG. 6. FIG. 5 is a block diagram showing the detection structure 40 and the others. The upper part of FIG. 6 is a plan view schematically showing the heater 22 and the detection structure 40, and the lower part of FIG. 6 is a graph showing the temperature distribution of the heater 22.

As shown in FIG. 3, FIG. 5 and the upper part of FIG. 6, the detection structure 40 includes two heat source temperature detection members 41, two power interrupting members 42, two fixing temperature detection members 43, and a medium detection member 44. In the upper part of FIG. 6, the heat source temperature detection member 41, the power interrupting member 42, the fixing temperature detection member 43, and the medium detection member 44 are schematically shown, and their exact shapes and positions are not shown.

<Heat Source Temperature Detection Member> The heat source temperature detection member 41 is, for example, a temperature sensor such as a thermistor, and is provided in contact with the upper surface of the substrate 30 of the heater 22 (see FIG. 3). As shown in the upper part of FIG. 6, the two heat source temperature detection members 41 correspond to the first resistance heating element 32A and the second resistance heating element 32B, and are disposed in the short region B1 of the heater 22. Specifically, one heat source temperature detection member 41 is disposed on the substrate 30 facing the first resistance heating element 32A adjacent to the boundary BL in the short region B1. The other heat source temperature detection member 41 is disposed on the substrate 30 facing the second resistance heating element 32B located at one end (left end) in the axial direction. The heat source temperature detection member 41 is electrically connected to the control device 8 via a control circuit or the like (not shown) (see FIG. 5). The heat source temperature detection member 41 detects the temperature of the heater 22, and transmits a detection signal to the control device 8.

<Power Interrupting Member> The power interrupting member 42 is, for example, a heat-sensitive element such as a thermocut, and is provided in contact with the upper surface of the heater 22 (the substrate 30). As shown in the upper part of FIG. 6, the two power interrupting members 42 correspond to the first resistance heating element 32A and the second resistance heating element 32B, and are disposed in the long region B2 of the heater 22. More specifically, one power interrupting member 42 is disposed on the substrate 30 facing the first resistance heating element 32A adjacent to the boundary BL in the long region B2. The other power interrupting member 42 is disposed on the substrate 30 facing the second resistance heating element 32B located at the other end (right end) in the axial direction. The power interrupting member 42 is interposed in the control circuit (see FIG. 5) for connecting the heater 22 (the heat generating part 31) and the power source 35, and interrupts the power supplied to the heater 22 when the temperature of the heater 22 reaches the predetermined temperature or higher. The power interrupting member 42 is not under the control of the control device 8 and operates independently.

When the power interrupting member 42 is operated and the power supply is interrupted, the entire image forming apparatus 1 is stopped. Thereafter, an expert worker performs restoration work of the image forming apparatus 1, such as replacing the power interrupting member 42, so that the image forming process can be restored again in a state capable of performing the image forming process. In other words, once the power interrupting member 42 is operated, it cannot be restored by the user's operation, and the image forming apparatus 1 cannot be used for a certain period of time.

<Fixing Temperature Detection Member> The fixing temperature detection member 43 is, for example, a temperature sensor such as a thermistor, and is provided in front of the inner space of the fixing belt 20 in a state of being in contact with the inner surface of the fixing belt 20 (see FIG. 3). As shown in the upper part of FIG. 6, the two fixing temperature detection members 43 are disposed in the short region B1 of the heater 22 corresponding to the first resistance heating element 32A and the second resistance heating element 32B. More specifically, one fixing temperature detection member 43 is provided at substantially the same position in the axial direction as the one heat source temperature detection member 41, and the other fixing temperature detection member 43 is provided at substantially the same position in the axial direction as the other heat source temperature detection member 41. The fixing temperature detection member 43 is electrically connected to the control device 8 via the control circuit or the others (see FIG. 5). The fixing temperature detection member 43 detects a temperature of the fixing belt 20 and transmits a detection signal to the control device 8.

<Medium Detection Member> The medium detection member 44 is, for example, a reflective optical sensor, and is supported by the frame of the fixing device 7 on the upstream side of the pressure region N (see FIG. 3). As shown in the upper part of FIG. 6, the medium detection member 44 is disposed corresponding to the long region B2 of the heater 22. More specifically, the medium detection member 44 is provided at a position where the vicinity of the right end of the small-size paper P can be detected from below. The medium detection member 44 is electrically connected to the control device 8 via the control circuit or the others (see FIG. 5). The medium detection member 44 detects the paper P entering the pressure region N and transmits a detection signal to the control device 8.

[Operation of Detection Structure] An example of the operation (temperature control method) of the above-described detection structure 40 will be described. When the heat generating part 31 starts to generate heat with the start of execution of the image forming process, the heat source temperature detection member 41 and the fixing temperature detection member 43 detect the temperature of the resistance heating element 32 and the temperature of the fixing belt 20, respectively, and transmit the detection results to the control device 8.

<Detection by Heat Source Temperature Detection Member> The control device 8 determines whether the heater 22 (heat generating part 31) is normally operated based on the detection result of the heat source temperature detection member 41. For example, the control device 8 determines whether the detection result of the heat source temperature detection member 41 is within a desired temperature range (target temperature) previously stored in the memory, and controls the heater 22 (or the power source 35) so as to maintain the target temperature. When the detection result of the heat source temperature detection member 41 exceeds the heat source upper limit temperature stored in the memory in advance, the control device 8 determines that an abnormality has occurred in the heater 22 and performs control to stop power supply to the heat generating part 31.

<Detection by Fixing Temperature Detection Member> The temperature of the fixing belt 20 starts to rise after the temperature rise of the heater 22. In a state where the heater 22 is maintained at the target temperature, the control device 8 determines whether the temperature of the fixing belt 20 is within a desired temperature range (fixing temperature) based on the detection result of the fixing temperature detection member 43, and controls the heater 22 (or the power source 35) so as to maintain the fixing temperature. When the detection result of the fixing temperature detection member 43 exceeds the fixing upper limit temperature stored in the memory in advance, the control device 8 determines that an abnormality has occurred in the heater 22 and performs control to stop the power source to the heat generating part 31.

When the control device 8 executes the stop control of the heater 22, the control device 8 determines whether the detection results of the heat source temperature detection member 41 and the fixing temperature detection member 43 are lowered to the temperature at which the image forming process (fixing process) can be resumed (resumable temperature), and when it is determined that the temperature is lowered to the resumable temperature, it allows the resumption of the image forming process (fixing process). Although the use of the image forming apparatus 1 is limited until the temperature is lowered to the resumable temperature, the user has little disadvantage because the return time from the stop control by the control device 8 is extremely short compared with the return time from the operation of the power interrupting member 42.

In the state where the fixing belt 20 is maintained at the fixing temperature, the control device 8 executes the image forming process and the fixing process described above. When an abnormality occurs in the heater 22 and the temperature of the heater 22 reaches the predetermined temperature (for example, 250° C.) or higher, the power interrupting member 42 forcibly interrupts the power supply to the heat generating part 31.

Incidentally, as shown in the lower part of FIG. 6, when the heat generating part 31 generates heat, the temperature of the short region B1 of the heater 22 tends to be higher than that of the long region B2. The short region B1 of the heater 22 is more likely to reach a high temperature earlier than the long region B2. Because the volume (heat capacity) of the substrate 30 is larger in the long region B2 than in the short region B1, more heat is absorbed in the long region B2 than in the short region B1. If the power interrupting member 42 is disposed in the short region B1 of the heater 22, the power interrupting member 42 may be operated before the heat source temperature detection member 41 and the fixing temperature detection member 43 detect an excessive temperature rise (abnormal temperature rise) of the heater 22. As described above, when the power interrupting member 42 is operated, the restoration work by the expert worker is required, so that the period in which the image forming apparatus 1 cannot be used is prolonged, which is disadvantageous to the user. Therefore, in the fixing device 7 according to the present embodiment, by arranging the power interrupting member 42 in the long region B2, the heat source temperature detection member 41 and the fixing temperature detection member 43 detect an excessive temperature rise of the heater 22 before the power interrupting member 42 is operated. Thus, the control device 8 can stop the heater 22, and the operation of the power interrupting member 42 is suppressed.

<Detection by Medium Detection Member> As shown in the upper part of FIG. 6, in the fixing device 7 according to the present embodiment, the heat source temperature detection member 41 and the fixing temperature detection member 43 are provided in the short region B1 (left side) of the heater 22, and the temperatures of the heater 22 and the fixing belt 20 can be directly detected. On the other hand, there is no member for directly detecting the temperature of the heater 22 or the fixing belt 20 in the long region B2 (right side) of the heater 22, and it is difficult to grasp the excessive temperature rise of the heater 22 to the extent that the power interrupting member 42 does not operate in the long region B2. Therefore, in the fixing device 7 according to the present embodiment, the excessive temperature rise of the heater 22 in the long region B2 is predicted by using the medium detection member 44 disposed in the long region B2. Hereinafter, it will be specifically described.

The prediction of the excessive temperature rise of the heater 22 using the medium detection member 44 is based on the phenomenon that when the paper P on which the toner image is formed passes through the pressure region N, the paper P and the toner take heat away from the fixing belt 20 to lower the temperature of the fixing belt 20 and the heater 22. The medium detection member 44 detects the paper P entering the pressure region N and transmits the detection result to the control device 8. The control device 8 determines that the paper P is normally conveyed based on the detection result of the medium detection member 44, and predicts that the excessive temperature rise of the fixing belt 20 and the heater 22 is suppressed by the paper P or the others passing through the pressure region N.

On the other hand, when the medium detection member 44 cannot detect the paper P entering the pressure region N, the control device 8 determines that the conveyance failure of the paper P occurs. The “conveyance failure” of the paper P means that the paper P is clogged in the upstream side portion of the conveyance path 9A, or that the paper P is conveyed in a position shifted to the left side (the short region B1), and the like. When the conveyance failure of the paper P occurs, since the paper P or the like does not pass through the pressure region N in the long region B2, the control device 8 predicts that the excessive temperature rise of the fixing belt 20 and the heater 22 occurs in the long region B2 of the heater 22. The control device 8 performs control to stop power supply to the heat generating part 31 when the conveyance failures are detected at a plurality of times, for example.

In the fixing device 7 according to the present embodiment described above, the heat generating part 31 of the heater 22 is formed at a position shifted in one direction (left direction) from the center in the axial direction on the lower surface of the substrate 30, and the heat source temperature detection member 41 is disposed in the short region B1 of the heater 22 (see FIG. 6). According to this configuration, since the temperature rises in the short region B1 earlier than in the long region B2, the heat source temperature detection member 41 provided in the short region B1 can detect an abnormal temperature rise of the heater 22 in a timely manner. As a result, since it is possible to control the heater 22 to stop, the damage of the fixing device 7 due to excessive heating can be suppressed.

In the fixing device 7 according to the present embodiment, the power interrupting member 42 is disposed in the long region B2 of the heater 22 (see FIG. 6). According to this configuration, since the temperature rises in the long region B2 later than in the short region B1, it is possible to prevent the power interrupting member 42 from operating before the heat source temperature detection member 41 disposed in the short region B1 detects the excessive temperature rise of the heater 22. Thus, for example, the restoration work of the fixing device 7, such as the replacement of the power interrupting member 42, is not required, and the time required for resuming the fixing process can be shortened.

In the fixing device 7 according to the present embodiment, the fixing temperature detection member 43 is disposed corresponding to the short region B1 of the heater 22 (see FIG. 6). According to this configuration, the excessive temperature rise of the fixing belt 20 can be detected in a timely manner by the fixing temperature detection member 43 provided in the short region B1. As a result, since it is possible to control the heater 22 to stop, the damage to the fixing belt 20 due to excessive heating can be suppressed. Further, since the fixing belt 20 can be controlled to be maintained at a desired temperature based on the detection result of the fixing temperature detection member 43, the toner on the paper P can be properly thermally fixed. Thus, a good fixed image can be obtained.

In the fixing device 7 according to the present embodiment, the medium detection member 44 is disposed corresponding to the long region B2 of the heater 22 (see FIG. 6). According to this configuration, for example, when the medium detection member 44 does not detect the paper P, it can be predicted that the temperature rises in the long region B2. Thereby, since the excessive temperature rise of the heater 22 in the long region B2 is estimated in a timely manner, it is possible to control that the heater 22 is stopped before the operation of the power interrupting member 42.

In the fixing device 7 according to the present embodiment, the heat generating part 31 is disposed at a position shifted in the left direction from the center in the axial direction on the lower surface of the substrate 30, but it is not limited thereto, and may be formed at a position shifted in the right direction from the center in the axial direction (not shown).

In the fixing device 7 according to the present embodiment, the heat generating part 31 includes the four first resistance heating elements 32A and the four second resistance heating elements 32B, but the present invention disclosure is not limited thereto. The heat generating part 31 may have at least one first resistance heating element 32A and at least one second resistance heating element 32B (not shown). Further, in the fixing device 7 according to the present embodiment, the heat generating part 31 includes the two circuits of the first resistance heating element 32A and the second resistance heating element 32B, but the present disclosure is not limited thereto. For example, the heat generating part 31 may include one circuit of only the first resistance heating element 32A, or may have three or more circuits by adding other resistance heating elements to the resistance heating element 32 (not shown). Further, the position and shape of the wiring 33 and the terminals 34 may be freely changed in accordance with the number and position of the resistance heating elements 32 (not shown).

In the fixing device 7 according to the present embodiment, the two heat source temperature detection members 41, the two power interrupting members 42, and the two fixing temperature detection members 43 are provided corresponding to the first resistance heating element 32A and the second resistance heating element 32B, but the present disclosure is not limited thereto. The heat source temperature detection member 41, at least one of the power interrupting member 42 and the fixing temperature detection member 43 may be provided corresponding to the number of circuits formed by the resistance heating element 32 (not shown).

In the fixing device 7 according to the present embodiment, the detection structure 40 includes the heat source temperature detection member 41, the power interrupting member 42, the fixing temperature detection member 43, and the medium detection member 44, but the present disclosure is not limited thereto. For example, as other detection structures, the medium detection member 44 may be omitted, the fixing temperature detection member 43 and the medium detection member 44 may be omitted, and the power interrupting member 42, the fixing temperature detection member 43 and the medium detection member 44 may be omitted (not shown). That is, the detection structure may include at least the heat source temperature detection member 41 (not shown).

In the fixing device 7 according to the present embodiment, the heat source temperature detection member 41 and the fixing temperature detection member 43 are the thermistors, but they are not limited thereto, and other temperature sensors such as thermocouples and temperature measuring resistors may be used. Although the fixing temperature detection member 43 is in contact with the inner surface of the fixing belt 20, the present disclosure is not limited thereto. For example, the fixing temperature detection member 43 may be in contact with the outer surface of the fixing belt 20 (not shown). Further, for example, the fixing temperature detection member 43 may be a non-contact temperature detection device such as an infrared radiation thermometer, and may be provided in a non-contact manner with the inner or outer surface of the fixing belt 20 (not shown). Further, although the medium detection member 44 is a reflection type optical sensor, it is not limited thereto, and other sensors such as a transmission type optical sensor and a microswitch may be used.

In the fixing device 7 according to the present embodiment, although the pressure roller 21 is rotationally driven to rotate and the fixing belt 20 is driven to be rotated accordingly, the fixing belt 20 may be rotationally driven to rotate and the pressure roller 21 may be rotated accordingly.

In the description of the above-described embodiment, the present disclosure is applied to the monochrome image forming apparatus 1 as an example, but the present disclosure is not limited thereto, and the present disclosure may be applied to, for example, a color printer, a copying machine, a facsimile machine, or a multifunction peripheral.

It should be noted that the description of the above embodiments shows one aspect of the fixing device and the image forming apparatus according to the present disclosure, and the technical range of the present invention disclosure is not limited to the above embodiments. The present disclosure may be varied, replaced, and modified without departing from the spirit of the technical thought, and the scope of the claims includes all embodiments which may be included within the scope of the technical thought.

1. A fixing device comprising:
a fixing belt which is formed in a cylindrical shape and heats toner on a medium while rotating around an axis;
a pressure member which forms a pressure region between the fixing belt and the pressure member, and pressurizes the toner on the medium passing through the pressure region while rotating around an axis;
a heater which is in contact with an inner surface of the fixing belt in the pressure region and heats the fixing belt; and
a heat source temperature detection member which detects a temperature of the heater, wherein
the heater include:
a substrate extending in an axial direction of the axis of the fixing belt, and
a heat generating part which is formed at a position shifted in one direction from a center in the axial direction on one surface of the substrate facing the pressure region, and generates heat when being powered,
the heater is divided into a short region having a shorter length in the axial direction and a long region having a longer length in the axial direction by the center of the heat generating part in the axial direction as a boundary, and
the heat source temperature detection member is disposed in the short region of the heater.

2. The fixing device according to claim 1, comprising:
a power interrupting member which is disposed in the long region of the heater, and interrupts power supply to the heater when a temperature of the heater reaches a predetermined temperature or higher.

3. The fixing device according to claim 2, comprising:
a fixing temperature detection member which is disposed corresponding to the short region of the heater and detects a temperature of the fixing belt.

4. The fixing device according to claim 3, comprising:
a medium detection member which is disposed corresponding to the long region of the heater and detects the medium entering the pressure region.

5. An image forming apparatus, comprising the fixing device according to claim 1.
